(19) United States
(12) Patent Application Publication
(10) Pub. No.: US 2008/0048431 A1
(43) Pub. Date: Feb. 28, 2008

(54) Method of advertising using a mechanical fastener comprising a pair of releasably connectable strips

(76) Inventors: Shlomo Yosef, Hertzlia (IL); Avraham Shachar, Macabim (IL)

Correspondence Address: CHARLES E. BAXLEY, ESQ., 90 JOHN STREET, THIRD FLOOR, NEW YORK, NY, 10038, US

(21) Appl. No.: 11/508,641

(22) Filed: Aug. 23, 2006

(51) Int. Cl. B42D 15/00; G09F 3/08

(52) U.S. Cl. 283/67; 283/56; 40/662

(57) ABSTRACT

A method of advertising using a mechanical fastener comprising a pair of cooperating strips, including the steps of: fabricating the mechanical fastener comprising the pair of cooperating strips, wherein one strip is a stationary strip and the other strip is a removable strip; annotating the stationary strip with the advertising; attaching the stationary strip to a stationary object and the removable strip to a removable object; and concealing the advertising on the stationary strip by the removable strip so as to allow the advertising on the stationary strip to not be visible when the removable strip is engaged with the stationary strip, but when the removable strip is removed from the stationary strip, the advertising on the stationary strip is allowed to be visible.

### BACKGROUND OF THE INVENTION

### A. Field of the Invention

Embodiments of the present invention relate to a method of advertising, and more particularly, the embodiments of the present invention relate to a method of advertising using a mechanical fastener comprising a pair of releasably attachable strips.

### B. Description of the Prior Art

Numerous innovations for attachments have been provided in the prior art, which will be described below in chronological order to show advancement in the art, and which are incorporated herein by reference thereto. Even though these innovations may be suitable for the specific individual purposes to which they address, they each differ in structure and/or operation and/or purpose from the embodiments of the present invention in that they do not teach a method of advertising using a mechanical fastener comprising a pair of releasably attachable strips.

(1) U.S. Pat. No. 4,169,303 to Lemelson.

U.S. Pat. No. 4,169,303 issued to Lemelson on Oct. 2, 1979 in class 24 and subclass 204 teaches structures provided in strip or sheet-like fastening materials formed by molding together with an apparatus and method for producing same. In one form, a strip-like fastening material is formed by molding a plurality of narrow strips, each containing at least one row of fastening elements extending longitudinally therealong and guiding the strips into edgewise abutment whereafter they are fastened together, such as by welding, to form a wider strip or sheet of fastening material containing a plurality of rows of molded fastening elements. The fastening elements may include molded hooks with or without barbs, arrowhead formations, mushroom-like formations, loops of plastic, or otherwise formed formations that may intermesh with the same or different formations of another strip to effect the fastening of the two strips together. In a particular form, hook or barb-shaped elements are formed along respective strips of metal or plastic by stamping or molding, and the strips are hingedly joined together.

(2) U.S. Pat. No. 5,077,870 to Melbye et al.

U.S. Pat. No. 5,077,870 issued to Melbye et al. on Jan. 7, 1992 in class 24 and subclass 452, as shown in FIG. 1, which is a diagrammatic side elevational view of a prior art pair of cooperating mushroom-type hook strips, teaches a pair of cooperating mushroom-type hook strips 10. Each mushroom-type hook strip 10 has a flexible backing 12 of thermoplastic resin, and integral with the flexible backing 12, an array of upstanding stems 14 distributed across one face 16 of the flexible backing 12 and having another face 18 opposite thereto. Each upstanding stem 14 has a mushroom head 20. The upstanding stems 14 have a molecular orientation as evidenced by a birefringence value of at least 0.001. The mushroom-type hook strip 10 can be produced continuously by injecting resin into cavitites of a cylindrical mold while evacuating and cooling the cavities, so that the cooled resin becomes molecularly oriented, thus affording to the upstanding stems 14 excellent stiffness, durability, and tensile and flexural strength.

(3) U.S. Pat. No. 5,529,271 to Dunchock.

U.S. Pat. No. 5,529,271 issued to Dunchock on Jun. 25, 1996 in class 248 and subclass 205.2 teaches a bracket mounting system encompassing both an apparatus and method enabling the mounting of a portable cellular phone in a manner providing safety and utility to a user. The bracket system includes a bracket support attached to a vehicle dash or console from a pivoting hinge. The bracket support of the bracket system can reversibly engage the pivoting hinge to present either a first surface or a second surface to the user. The first surface of the bracket support has a strike plate and some other engagement structure to facilitate the wear-resistant mounting, removal, and re-mounting of a portable cellular phone. The second surface has a VELCRO®-type material, preferably of hook members, engaging a complementary surface of loop members that may be attached to a portable cellular phone.

(4) U.S. Pat. No. 5,813,583 to Benedeti.

U.S. Pat. No. 5,813,583 issued to Benedeti on Sep. 29, 1998 in class 224 and subclass 483 teaches a portable CD holder for holding a portable compact disc player for use in a motor vehicle. The holder includes a bracket arrangement adapted for securement to an underside of a dashboard of a vehicle, below a radio thereof. A pair of circular hook and loop patches are provided. One of the hook and loop patches is secured to the bracket arrangement. The other of the hook and loop patches is secured to an underside of a portable CD player. The pair of hook and loop patches secure the portable CD player to the bracket arrangement.

### (5) U.S. patent application Publication No. 2001/0045036 to Maxwell et al.

U.S. patent application Publication No. 2001/0045036 published to Maxwell et al. on Nov. 29, 2001 in class 40 and subclass 593 teaches a product to assist a vehicle owner and user in properly keeping track of the amount of miles driven in a particular vehicle. The goal of the product is to ensure that regular oil changes will occur approximately every 3,000 miles, which is the usual recommended interval that oil changes occur for most vehicles. The product is a multipage notepad that is preferably one inch tall by one and one-half inches wide, and which can be fastened to an automobile dashboard by way of a mounted VELCRO® tab, with an accompanying VELCRO® tab mounted onto the dashboard. The product is designed to provide a user with the ability to perform a quick mathematical calculation in order to determine whether it is presently time to perform an oil change.

(6) U.S. Pat. No. 6,489,003 to Levitt et al.

U.S. Pat. No. 6,489,003 issued to Levitt et al. on Dec. 3, 2002 in class 428 and subclass 100 teaches an elastic web of material having a multiplicity of stems extending from at least one side of the web. The web includes a first continuous layer of elastic material having a first side, a second side, and a second layer of material. The second layer of material has a first side facing the first side of the first layer and a second side from which the stems extend. The first and second layers of material are joined together. The second layer of material can be formed of thermoplastic material or melt-processable-polymeric material. The first and second layers of material are melt formed. They are joined by coextrusion or lamination to form a multiple layer sheet on which a multiplicity of stems are formed on at least the second layer by a process, such as embossing the stems into the heated web using a patterned roll or mold.

(7) U.S. Pat. No. 6,491,194 to Marvin.

U.S. Pat. No. 6,491,194 issued to Marvin on Dec. 10, 2002 in class 224 and subclass 483 teaches a cell phone holder for motor vehicles providing for placement of a cellular phone at any convenient location desired in a motor vehicle or other area as desired. The cell phone holder essentially includes a relatively narrow back or spine portion with opposed upper and lower lateral arms extending therefrom. The arms are open between their facing forward ends to allow complete access to the cellular phone contained within the holder. The back of the holder includes one portion of a hook and loop fabric material thereon, which removably attaches to another portion of a mating material secured to another surface, such as automobile dash, etc. A person wishing to use the phone may easily grasp the phone and withdraw it from the open holder for use as desired. One or more spacers may be provided to adjust for different sizes of phones as desired.

### (8) U.S. patent application Publication No. 2005/0039313 to Melbye et al.

U.S. patent application publication No. 2005/0039313 published to Melbye et al. on Feb. 24, 2005 in class 24 and subclass 452 teaches a mushroom-type hook strip for a hook-and-loop fastener having a flexible backing of thermoplastic resin and, integral with the backing, an array of upstanding stems distributed across at least one face of the backing, each having a mushroom head. The stems have a molecular orientation as evidenced by a birefringence value of at least 0.001. The mushroom-type hook strip can be produced continuously by injecting resin into cavities of a cylindrical mold, while evacuating and cooling the cavities, so that the cooled resin becomes molecularly oriented, thus affording to the stems excellent stiffness, durability, and tensile and flexural strength.

It is apparent that numerous innovations for attachments have been provided in the prior art that are adapted to be used. Furthermore, even though these innovations may be suitable for the specific individual purposes to which they address, they would not be suitable for the purposes of the present invention as heretofore described, namely, a method of advertising using a mechanical fastener comprising a pair of releasably attachable strips.

### SUMMARY OF THE INVENTION

Thus, an object of the embodiments of the present invention is to provide a method of advertising using a mechanical fastener comprising a pair of cooperating removably attachable strips that avoids the disadvantages of the prior art.

Briefly stated, another object of an embodiment of the present invention is to provide a method of advertising using a mechanical fastener comprising a pair of cooperating mushroom-type hook strips, including the steps of: fabricating the mechanical fastener comprising the pair of cooperating mushroom-type hook strips, wherein one mushroom-type hook strip is a stationary mushroom-type hook strip and the other mushroom-type hook strip is a removable mushroom-type hook strip; annotating the stationary mushroom-type hook strip and/or the removable mushroom-type hook strip with the advertising; attaching the stationary mushroom-type hook strip to a stationary object and the removable mushroom-type hook strip to a removable object; and concealing the advertising on the stationary mushroom-type hook strip by the removable mushroom-type hook strip so as to allow the advertising on the stationary mushroom-type hook strip to not be visible when the removable mushroom-type hook strip is engaged with the stationary mushroom-type hook strip, but when the removable mushroom-type hook strip is removed from the stationary mushroom-type hook strip, the advertising on the stationary mushroom-type hook strip is allowed to be visible and likewise the advertising on the removable mushroom-type hook strip is allowed to be visible.

The novel features considered characteristic of the embodiments of the present invention are set forth in the appended claims. The embodiments of the present invention themselves, however, both as to their construction and their method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic side elevational view of a prior art pair of cooperating mushroom-type hook strips;

FIGS. 2A-2B are a flowchart of the method of advertising using a mechanical fastener comprising a pair of cooperating mushroom-type hook strips of the embodiments of the present invention;

FIG. 3 is a flowchart of the method of annotating the stationary mushroom-type hook strip with the advertising of the method of advertising using a mechanical fastener comprising a pair of cooperating mushroom-type hook strips of an embodiment of the present invention shown in FIGS. 2A-2B;

FIG. 4 is a flowchart of another method of annotating the stationary mushroom-type hook strip with the advertising of the method of advertising using a mechanical fastener comprising a pair of cooperating mushroom-type hook strips of another embodiment of the present invention shown in FIGS. 2A-2B;

FIG. 5 is a flowchart of the method of disposing the advertising on the side of the stationary mushroom-type hook strip that is opposite to that side of the stationary mushroom-type hook strip that cooperates with the removable mushroom-type hook strip of the method of annotating the stationary mushroom-type hook strip with the advertising of the method of advertising using a mechanical fastener comprising a pair of cooperating mushroom-type hook strips of an embodiment of the present invention shown in FIG. 3; and

FIG. 6 is a flowchart of the method of disposing the advertising on the side of the stationary mushroom-type hook strip that cooperates with the removable mushroom-type hook strip of the method of annotating the stationary mushroom-type hook strip with the advertising of the method of advertising using a mechanical fastener comprising a pair of cooperating mushroom-type hook strips of another embodiment of the present invention shown in FIG. 4.

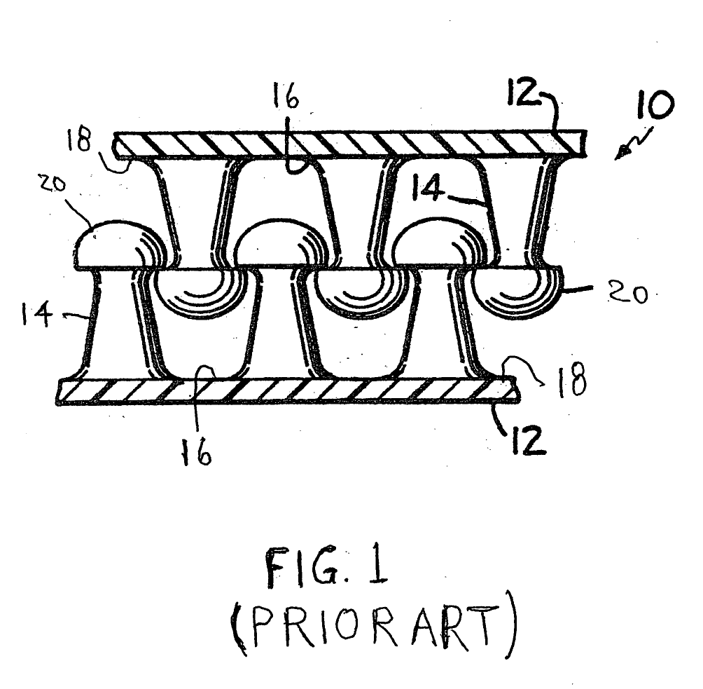

### LIST OF REFERENCE NUMERALS UTILIZED IN THE DRAWING

### A. Prior Art

10 pair of cooperating mushroom-type hook strips
12 flexible backing of each strip of pair of cooperating mushroom-type hook strips 10
14 array of upstanding stems on one face 16 of flexible backing 12 of each strip of pair of cooperating mushroom-type hook strips 10
16 one face of flexible backing 12 of each strip of pair of cooperating mushroom-type hook strips 10
18 another face of flexible backing 12 of each strip of pair of cooperating mushroom-type hook strips 10 opposite to one face 16 of flexible backing 12 of each strip of pair of cooperating mushroom-type hook strips 10
20 mushroom head of each upstanding stem of array of upstanding stems 14 on one face 16 of flexible backing 12 of each strip of pair of cooperating mushroom-type hook strips 10

### B. Embodiments of Present Invention

30 advertising on stationary strip
30a advertising on removeable strip
32 mechanical fastener
34 stationary mushroom-type hook strip of pair of cooperating mushroom-type hook strips 10 of mechanical fastener 32
36 removable mushroom-type hook strip of pair of cooperating mushroom-type hook strips 10 of mechanical fastener 32
38 stationary object
40 removable object
42 transparent material
44 side of stationary mushroom-type hook strip 34 of pair of cooperating mushroom-type hook strips 10 of mechanical fastener 32
46 other side of stationary mushroom-type hook strip 34 of pair of cooperating mushroom-type hook strips 10 of mechanical fastener 32

### 5. DETAILED DESCRIPTION OF THE PREFERRED EMBODIMENT

### A. The Method of Advertising 30 Using a Mechanical Fastener 32 Comprising the Pair of Cooperating Mushroom-Type Hook Strips 10.

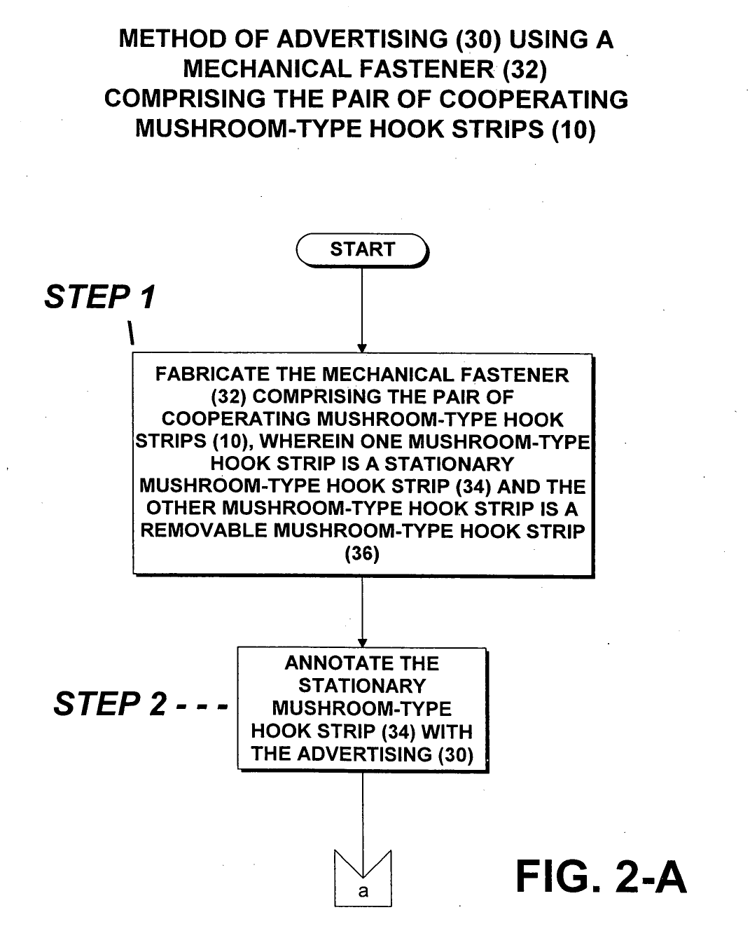

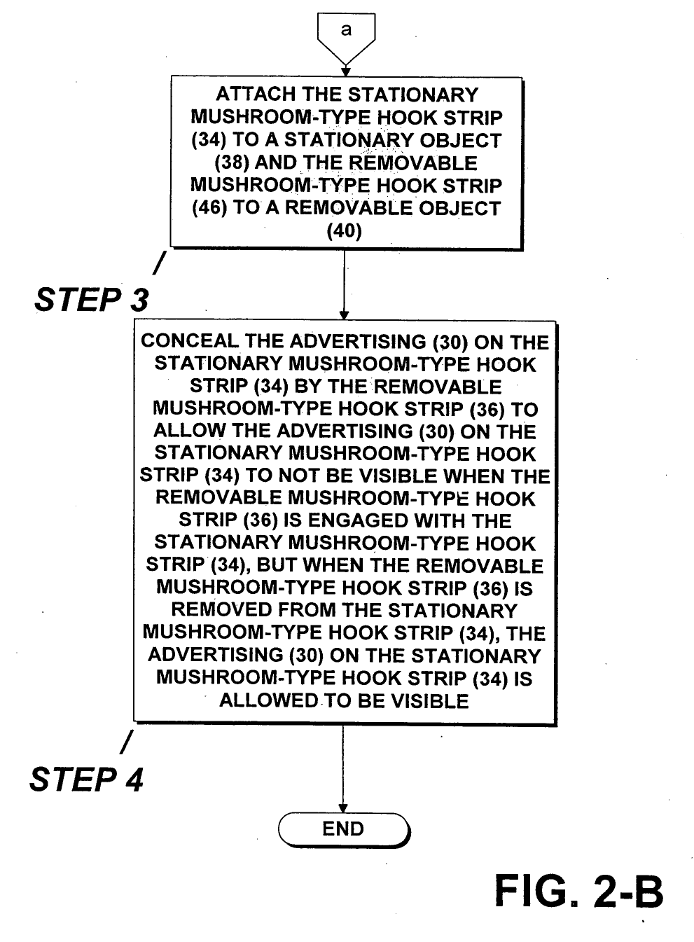

The method of advertising 30 using a mechanical fastener 32 comprising the pair of cooperating mushroom-type hook strips 10 can best be seen in FIGS. 2A-2B, which are a flowchart of the method of advertising using a mechanical fastener comprising a pair of cooperating mushroom-type hook strips of the embodiments of the present invention, and as such, will be discussed with reference thereto, and which comprises the steps of:
STEP 1: Fabricate the mechanical fastener 32 comprising the pair of cooperating mushroom-type hook strips 10, wherein one mushroom-type hook strip is a stationary mushroom-type hook strip 34 and the other mushroom-type hook strip is a removable mushroom-type hook strip 36.
STEP 2: Annotate the stationary mushroom-type hook strip 34 with the advertising 30. The removable mushroom-type hook strip 36 could also be so annotated with advertising 30a.
STEP 3: Attach the stationary mushroom-type hook strip 34 to a stationary object 38 and the removable mushroom-type hook strip 36 to a removable object 40.
STEP 4: Conceal the advertising 30 on the stationary mushroom-type hook strip 34 by the removable mushroom-type hook strip 36 so as to allow the advertising 30 on the stationary mushroom-type hook strip 34 to not be visible when the removable mushroom-type hook strip 36 is engaged with the stationary mushroom-type hook strip 34, but when the removable mushroom-type hook strip 36 is removed from the stationary mushroom-type hook strip 34, the advertising 30 on the stationary mushroom-type hook strip 34 is allowed to be visible.

### B. The Method of Annotating the Stationary Mushroom-Type Hook Strip 34 with the Advertising 30.

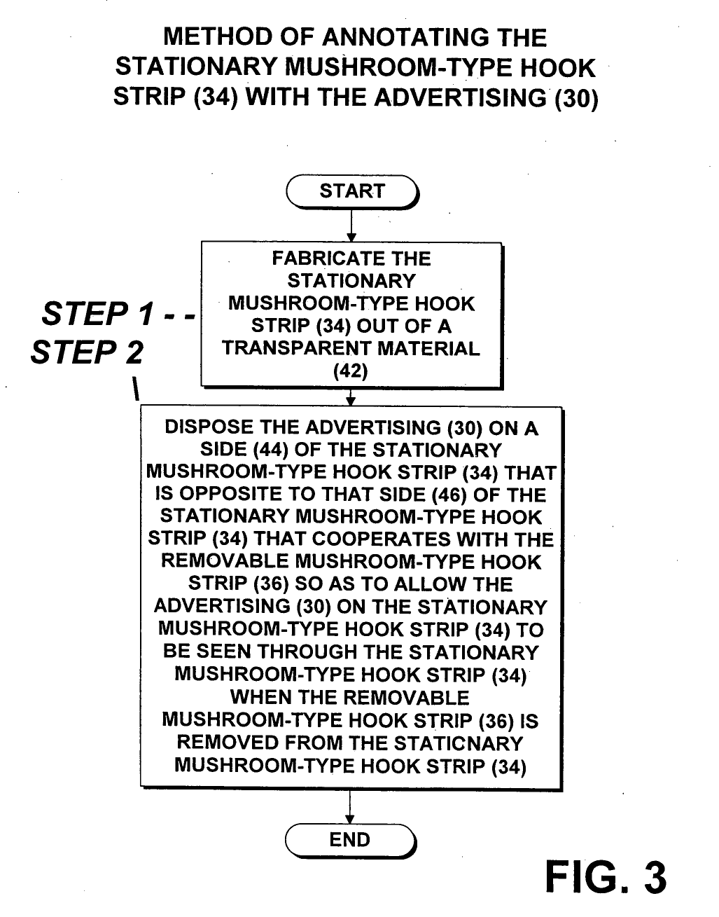

The method of annotating the stationary mushroom-type hook strip 34 with the advertising 30 can best be seen in FIG. 3, which is a flowchart of the method of annotating the stationary mushroom-type hook strip with the advertising of the method of advertising using a mechanical fastener comprising a pair of cooperating mushroom-type hook strips of an embodiment of the present invention shown in FIGS. 2A-2B, and as such, will be discussed with reference thereto, and which comprises the steps:
STEP 1: Fabricate the stationary mushroom-type hook strip 34 out of a transparent material 42.
STEP 2: Dispose the advertising 30 on a side 44 of the stationary mushroom-type hook strip 34 that is opposite to that side 46 of the stationary mushroom-type hook strip 34 that cooperates with the removable mushroom-type hook strip 36 so as to allow the advertising 30 on the stationary mushroom-type hook strip 34 to be seen through the stationary mushroom-type hook strip 34 when the removable mushroom-type hook strip 36 is removed from the stationary mushroom-type hook strip 34.

Advertising 30a could also be annotated to the removable mushroom-type hook strip.

### C. Another Method of Annotating the Stationary Mushroom-Type Hook Strip 34 with the Advertising 30.

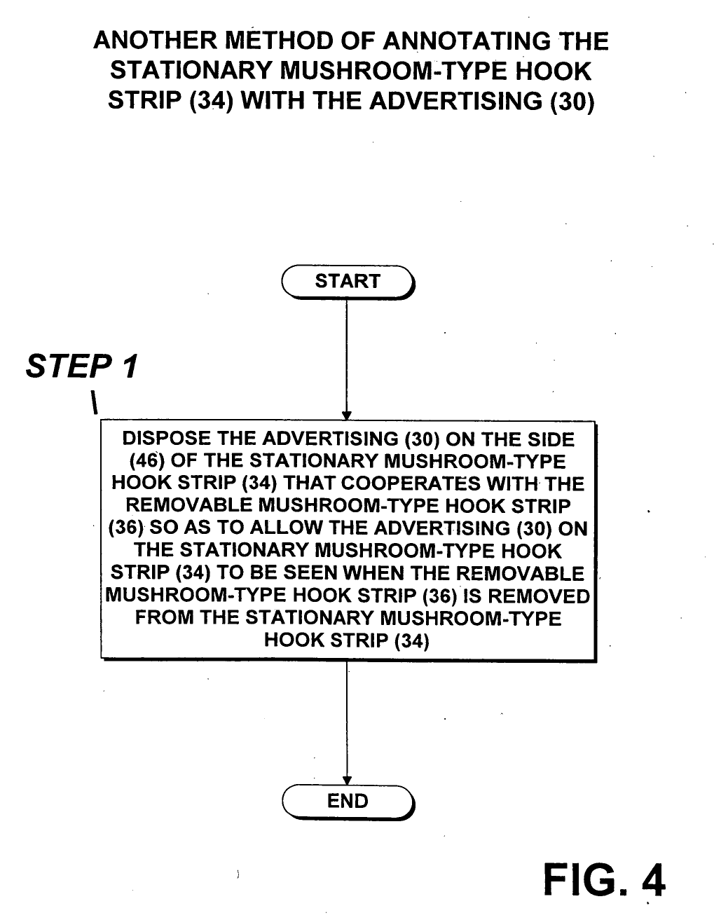

Another method of annotating the stationary mushroom-type hook strip 34 with the advertising 30 can best be seen in FIG. 4, which is a flowchart of another method of annotating the stationary mushroom-type hook strip with the advertising of the method of advertising using a mechanical fastener comprising a pair of cooperating mushroom-type hook strips of another embodiment of the present invention shown in FIGS. 2A-2B, and a such, will be discussed with reference thereto, and which comprises the step of:
STEP 1: Dispose the advertising 30 on the side 46 of the stationary mushroom-type hook strip 34 that cooperates with the removable mushroom-type hook strip 36 so as to allow the advertising 30 on the stationary mushroom-type hook strip 34 to be seen when the removable mushroom-type hook strip 36 is removed from the stationary mushroom-type hook strip 34.

### D. The Method of Disposing the Advertising 30 on the Side 44 of the Stationary Mushroom-Type Hook Strip 34 that is Opposite to that Side 46 of the Stationary Mushroom-Type Hook Strip 34 that Cooperates with the Removable Mushroom-Type Hook Strip 36.

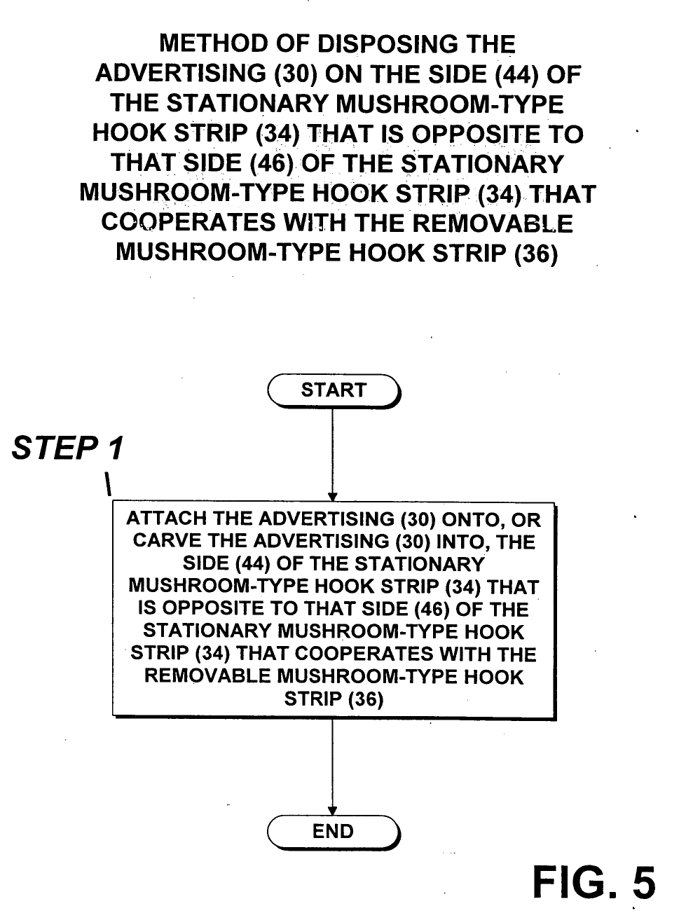

The method of disposing the advertising 30 on the side 44 of the stationary mushroom-type hook strip 34 that is opposite to that side 46 of the stationary mushroom-type hook strip 34 that cooperates with the removable mushroom-type hook strip 36 can best be seen in FIG. 5, which is a flowchart of the method of disposing the advertising on the side of the stationary mushroom-type hook strip that is opposite to that side of the stationary mushroom-type hook strip that cooperates with the removable mushroom-type hook strip of the method of annotating the stationary mushroom-type hook strip with the advertising of the method of advertising using a mechanical fastener comprising a pair of cooperating mushroom-type hook strips of an embodiment of the present invention shown in FIG. 3, and as such, will be discussed with reference thereto, and which comprises the step of:
STEP 1: Attach the advertising 30 onto, or carve the advertising 30 into, the side 44 of the stationary mushroom-type hook strip 34 that is opposite to that side 46 of the stationary mushroom-type hook strip 34 that cooperates with the removable mushroom-type hook strip 36.

### E. The Method of Disposing the Advertising 30 on the Side 46 of the Stationary Mushroom-Type Hook Strip 34 that Cooperates with the Removable Mushroom-Type Hook Strip 36.

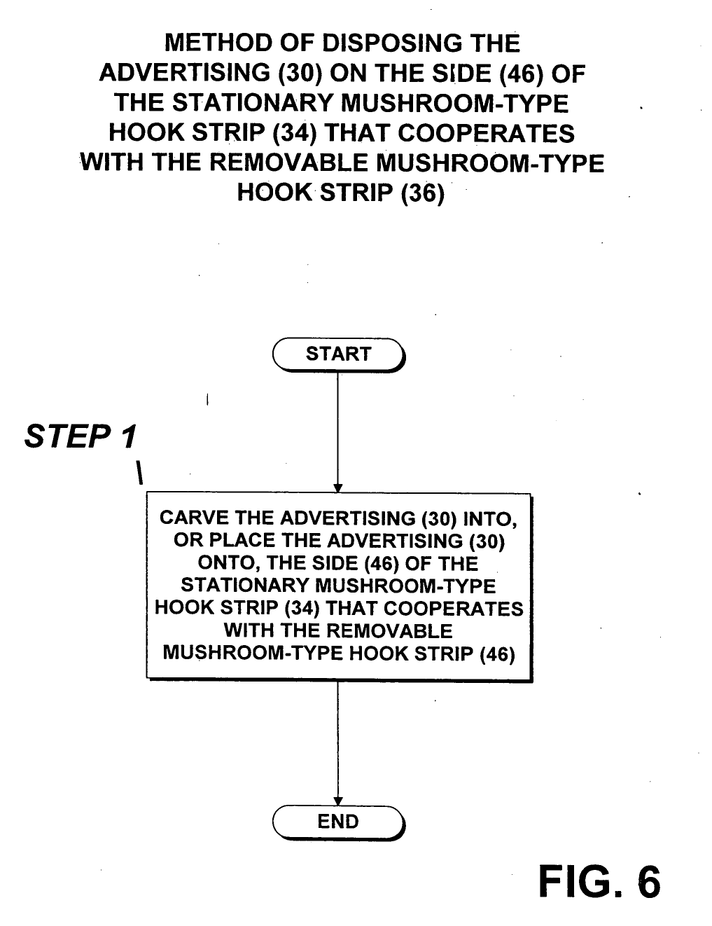

The method of disposing the advertising 30 on the side 46 of the stationary mushroom-type hook strip 34 that cooperates with the removable mushroom-type hook strip 36 can best be seen in FIG. 6, which is a flowchart of the method of disposing the advertising on the side of the stationary mushroom-type hook strip that cooperates with the removable mushroom-type hook strip of the method of annotating the stationary mushroom-type hook strip with the advertising of the method of advertising using a mechanical fastener comprising a pair of cooperating mushroom-type hook strips of another embodiment of the present invention shown in FIG. 4, and as such, will be discussed with reference thereto and comprises the step of:
STEP 1: Carve the advertising 30 into, or place the advertising 30 onto, the side 46 of the stationary mushroom-type hook strip 34 that cooperates with the removable mushroom-type hook strip 36.

### F. Conclusions.

It will be understood that each of the elements described above, or two or more together, may also find a useful application in other types of constructions differing from the types described above.

While the embodiments of the present invention have been illustrated and described as embodied in a method of advertising using a mechanical fastener comprising a pair of cooperating mushroom-type hook strips, however, they are not limited to the details shown, since it will be understood that various omissions, modifications, substitutions, and changes in the forms and details of the embodiments illustrated and their operation can be made by those skilled in the art without departing in any way from the spirit of the embodiments of the present invention. For example the method of advertising also is applicable to other types of removable fasteners. The advertising could be applied in other ways, such as branding or carving. And both the stationary and the removable strips could have messages applied thereto. The invention is particularly well suited to two (2) part messages, such as question and answer riddles.

Without further analysis, the foregoing will so fully reveal the gist of the embodiments of the present invention that others can, by applying current knowledge, readily adapt them for various applications without omitting features that, from the standpoint of prior art, fairly constitute characteristics of the generic or specific aspects of the embodiments of the present invention.

The invention claimed is:

1. A method of advertising using a mechanical fastener comprising a pair of cooperating mushroom-type hook strips, wherein each mushroom-type hook strip has a flexible backing of thermoplastic resin, and integral with the flexible backing, an array of upstanding stems distributed across one face of the flexible backing and having another face opposite thereto, wherein each upstanding stem has a mushroom head, and wherein said method comprises the steps of:
a) fabricating the mechanical fastener comprising the pair of cooperating mushroom-type hook strips, wherein one mushroom-type hook strip is a stationary mushroom-type hook strip and the other mushroom-type hook strip is a removable mushroom-type hook strip;
b) annotating the stationary mushroom-type hook strip with the advertising;
c) attaching the stationary mushroom-type hook strip to a stationary object and the removable mushroom-type hook strip to a removable object; and
d) concealing the advertising on the stationary mushroom-type hook strip by the removable mushroom-type hook strip so as to allow the advertising on the stationary mushroom-type hook strip to not be visible when the removable mushroom-type hook strip is engaged with the stationary mushroom-type hook strip, but when the removable mushroom-type hook strip is removed from the stationary mushroom-type hook strip, the advertising on the stationary mushroom-type hook strip is allowed to be visible.

2. The method of claim 1, wherein said annotating step comprises the steps of:
a) fabricating the stationary mushroom-type hook strip out of a transparent material; and
b) disposing the advertising on a side of the stationary mushroom-type hook strip that is opposite to that side of the stationary mushroom-type hook strip that cooperates with the removable mushroom-type hook strip so as to allow the advertising on the stationary mushroom-type hook strip to be seen through the stationary mushroom-type hook strip when the removable mushroom-type hook strip is removed from the stationary mushroom-type hook strip.

3. The method of claim 1, wherein said annotating step comprises the step of disposing the advertising on the side of the stationary mushroom-type hook strip that cooperates with the removable mushroom-type hook strip so as to allow the advertising on the stationary mushroom-type hook strip to be seen when the removable mushroom-type hook strip is removed from the stationary mushroom-type hook strip.

4. The method of claim 3, wherein said disposing step includes the step of attaching the advertising onto, or carving the advertising into, the side of the stationary mushroom-type hook strip that is opposite to that side of the stationary mushroom-type hook strip that cooperates with the removable mushroom-type hook strip.

5. The method of claim 3, wherein said disposing step includes the step of carving the advertising into, or placing the advertising onto, the side of the stationary mushroom-type hook strip that cooperates with the removable mushroom-type hook strip.

6. A method of advertising using a mechanical fastener comprising a pair of cooperating removably attachable strips, wherein each of the strips has a flexible backing of thermoplastic resin, and integral with the flexible backing, an array of connecting elements distributed across one face of the flexible backing and having another face opposite thereto, wherein each connecting element is provided with connecting means suitable for connecting with at least one of the connecting elements of its opposed cooperating strip, and wherein said method comprises the steps of:
a) fabricating the mechanical fastener comprising the pair of cooperating removably attachable strips, wherein one of the strips is a stationary strip and the other mushroom-type hook strip is a removable strip;
b) annotating the stationary strip with the advertising;
c) attaching the stationary strip to a stationary object and the removable strip to a removable object; and
d) concealing the advertising on the stationary hook strip by the removable trip so as to allow the advertising on the stationary strip to not be visible when the removable strip is engaged with the stationary strip, but when the removable mushroom-type hook strip is removed from the stationary mushroom-type hook strip, the advertising on the stationary mushroom-type hook strip is allowed to be visible.

7. The method of claim 6, wherein said annotating step comprises the steps of:
a) fabricating the stationary strip out of a transparent material; and
b) disposing the advertising on a side of the stationary strip that is opposite to that side of the stationary strip that cooperates with the removable strip so as to allow the advertising on the stationary strip to be seen when the removable strip is removed from the stationary mushroom-type hook strip.

8. The method of claim 6, wherein said annotating step comprises the step of disposing the advertising on the side of the stationary strip that cooperates with the removable strip so as to allow the advertising on the stationary strip to be seen when the removable strip is removed from the stationary strip.

9. The method of claim 8, wherein said disposing step includes the step of attaching the advertising onto, or carving the advertising into, the side of the stationary strip that is opposite to that side of the stationary strip that cooperates with the removable strip.

10. The method of claim 3, wherein said disposing step includes the step of carving the advertising into, or placing the advertising onto, the side of the stationary strip that cooperates with the removable strip.

11. The method of claim 6, wherein the removably attachable stip is also annotated with advertising.
